(19) United States
(12) Patent Application Publication
(10) Pub. No.: US 2025/0182571 A1
(43) Pub. Date: Jun. 5, 2025

(54) SYSTEMS AND METHODS FOR MONITORING WAGERING GAMES

(71) Applicant: M & M Entertainment, LLC, Bellwood, IL (US)

(72) Inventors: Frank Mugnolo, Bellwood, IL (US); Peter Mastroianni, New Rochelle, NY (US)

(73) Assignee: M & M Entertainment, LLC, Bellwood, IL (US)

(21) Appl. No.: 18/882,117

(22) Filed: Sep. 11, 2024

Related U.S. Application Data
(60) Provisional application No. 63/605,097, filed on Dec. 1, 2023.

(51) Int. Cl. G07F 17/32

(52) U.S. Cl. CPC G07F 17/3241; G07F 17/3206

(57) ABSTRACT

A method for monitoring a wagering game is provided. The method may comprise determining an initial phase of a wagering game, determining that a wager is positioned on a betting area, and determining an initial value of the wager at the initial phase, comprising capturing, via a camera positioned on the wagering game, one or more images of the wager on the play area, and analyzing image data of the one or more images of the wager to determine an initial value of the wager. The method may comprise determining at least one secondary phase of the wagering game, determining a value of the wager at one or more of the at least one secondary phases of the wagering game, and comparing the value of the wager at the initial phase to the value of the wager at the one or more of the at least one secondary phases.

### CROSS REFERENCE TO RELATED APPLICATIONS

This application claims priority to U.S. Provisional patent Application No. 63/605,097, filed on Dec. 1, 2023, the content of which is incorporated herein by reference in its entirety.

### TECHNICAL FIELD

Embodiments of the present disclosure relate to a wagering card game and systems and methods for monitoring the wagering card game.

### BACKGROUND

A casino may offer various games, such as card games, roulette, or craps, in which the rules result in the casino receiving slightly favorable odds over the players. As such, the casino will reap larger rewards as the volume of bets increase. However, cheating by players is one of the main factors that casinos face in reaping these rewards. Dealers are trained to detect cheating, and personnel viewing security videos of the game provide an additional layer of observation to detect cheating. However, it may be difficult to track wagers at different stages of a game. In particular, when there are many areas of a gaming table to observe, and more so, when there are many players at one gaming table.

### SUMMARY

According to an object of the present disclosure, a method for monitoring a wagering game is provided. The method may comprise determining an initial phase of a wagering game, determining that a wager is positioned on a betting area of the wagering game, and determining an initial value of the wager at the initial phase. The determining the initial value of the wager may comprise capturing, via a camera positioned on the wagering game, one or more images of the wager on the play area, and analyzing image data of the one or more images of the wager to determine an initial value of the wager. The method may comprise determining at least one secondary phase of the wagering game, determining a value of the wager at one or more of the at least one secondary phases of the wagering game, and comparing the value of the wager at the initial phase to the value of the wager at the one or more of the at least one secondary phases.

According to various embodiments, the method may further comprise, when the value of the wager at the initial phase is different from the value of the wager at the one or more of the at least one secondary phases, determining that a player has cheated.

According to various embodiments, during the wagering game, a dealer may deal one or more of a first set of 13 cards, which are laid out left to right on a row of spaces marked with denominations A, 2, 3, 4, 5, 6, 7, 8, 9, 10, J, Q, K, in that order, and, when a card, of the first set of 13 cards, matches the denomination of a space on which it was placed, dealing ends.

According to various embodiments, the determining the initial phase of the wagering game may comprise detecting that the dealer has begun dealing the first set of 13 cards.

According to various embodiments, during the wagering game, when no card, of the first set of 13 cards, matches the denomination of a space in which it was placed, the dealer may deal one or more of a second set of 13 cards, which are laid out left to right on a second row of spaces marked with denominations A, 2, 3, 4, 5, 6, 7, 8, 9, 10, J, Q, K, in that order, and, when a card, of the second set of 13 cards, matches the denomination of a space in which it is placed, dealing ends.

According to various embodiments, the determining the at least one secondary phase of the wagering game may comprise detecting that the dealer has begun dealing the second set of 13 cards.

According to various embodiments, during the wagering game, when no card, of the second set of 13 cards, matches the denomination of the space in which it was placed, the dealer may deal one or more of a third set of 13 cards, which are laid out left to right on a third row of spaces marked with denominations A, 2, 3, 4, 5, 6, 7, 8, 9, 10, J, Q, K, in that order, and, when a card, of the third set of 13 cards, matches the denomination of a space in which it is placed, dealing ends.

According to various embodiments, the determining the at least one secondary phase of the wagering game may comprise detecting that the dealer has begun dealing the third set of 13 cards.

According to various embodiments, during the wagering game, when no card, of the third set of 13 cards, matches the denomination of the space in which it was placed, the dealer may deal one or more of a fourth set of 13 cards, which are laid out left to right on a third row of spaces marked with denominations A, 2, 3, 4, 5, 6, 7, 8, 9, 10, J, Q, K, in that order, and, when a card, of the fourth set of 13 cards, matches the denomination of a space in which it is placed, dealing ends.

According to various embodiments, the determining the at least one secondary phase of the wagering game may comprise detecting that the dealer has begun dealing the fourth set of 13 cards.

According to various embodiments, the determining the at least one secondary phase of the wagering game may comprise detecting that the fourth set of cards has been completely dealt.

According to various embodiments, the determining the value of the wager at the one or more of the at least one secondary phases of the wagering game may comprise capturing, via the camera, in response to determining a secondary phase of the wagering game, one or more images of the wager at the secondary phase of the wagering game, and analyzing image data of the one or more images of the wager at the secondary phase of the wagering game to determine the value of the wager at the secondary phase of the wagering game.

According to various embodiments, the determining that the wager is positioned on the betting area may comprise capturing, via the camera positioned on the wagering game, one or more images of the wagering game, and analyzing image data of the one or more images to determine whether a feature of the wager is included in the image data of the play area.

According to various embodiments, the determining that the wager is positioned on the betting area may comprise monitoring a weight of the betting area, wherein the betting area is positioned on a weight sensor, and determining that the wager is positioned on the betting area when the weight of the betting area increases.

According to various embodiments, the determining that the wager is positioned on the betting area may comprise receiving a signal transmitted by a press of a button located on at least one of an area of the wagering game and a display screen of a security device, and the press of the button may indicate that the wager is positioned on the play area.

According to various embodiments, the determining that the wager is positioned on the betting area may indicate that the player initiated the wager.

According to various embodiments, the method may comprise, during the wagering game, identifying a winning wager, and, when the winning wager is identified, placing a marker on a winning wager indication area indicating which wager is the winning wager.

According to various embodiments, when a player makes a color wager and a dealt card matches a denomination of a space on which it was placed, the color wager may be the winning wager when a color of the dealt card matches a color of the color wager.

According to various embodiments, the color wager may comprise a red color wager.

According to various embodiments, the color wager may comprise a black color wager.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description.

FIG. 1 is a functional block diagram illustrating a casino.

FIG. 2A is an example gaming table within the casino.

FIG. 2B is a flowchart that illustrates a method of operating the gaming table of FIG. 2A.

FIG. 3 is a flowchart that illustrates monitoring the gaming table of FIG. 2A.

FIG. 4 is a block diagram depicting components (such as the server of FIG. 1) of the casino.

### DETAILED DESCRIPTION

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

Hereinafter, some embodiments of the present disclosure will be described in detail with reference to the drawings. In the drawings, the same reference numerals will be used throughout to designate the same or equivalent elements. In addition, a detailed description of well-known features or functions will be ruled out in order not to unnecessarily obscure the gist of the present disclosure.

In the following detailed description, numerous details are set forth in order to provide an understanding of a wagering program; however, it will be understood by those skilled in the art that different and numerous embodiments of the wagering program and the method of operation may be practiced without those specific details, and the claims and disclosure should not be limited to the embodiments, subassemblies, features, processes, methods, aspects, features or details specifically described and shown in the present disclosure. Further, particular features described in the present disclosure can be used in combination with other described features in each of the various possible combinations and permutations. Thus, the following more detailed description, as represented in the figures, is not intended to limit the scope of the present disclosure, but is merely representative of certain implementations in various different scenarios. While the various aspects are presented in the drawings, the drawings are not necessarily drawn to scale unless specifically indicated.

The following detailed description omits or only briefly describes conventional features of a casino, which are apparent to those skilled in the art. Moreover, unless otherwise specifically defined in the present disclosure, all terms are to be given their broadest possible interpretation including meanings implied from the specification as well as meanings understood by those skilled in the art and/or as defined in dictionaries, treatises, etc.

Embodiments disclosed in the present disclosure relate generally to casino gaming and, more particularly, to a casino security system for monitoring wagering games. The embodiments are described below with reference to the Figures.

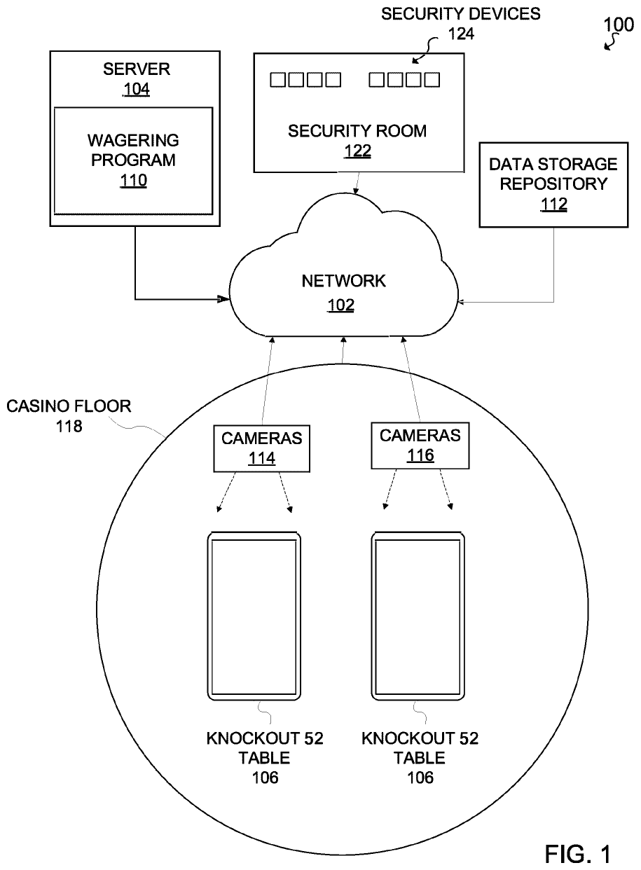

FIG. 1 is a functional block diagram illustrating an environment, such as a casino 100. FIG. 1 provides only an illustration of one implementation and does not imply any limitations with regard to the environments in which different embodiments may be implemented. Many modifications to the depicted environment may be made by those skilled in the art without departing from the scope of the embodiments of the present disclosure. The casino 100 may comprise a network 102, a server 104, which may be configured to operate a wagering program 110 (hereinafter “program 110”), a security room 122, a data storage repository 112, and a casino floor 118. The casino floor 118 may comprise one or more slot machines, one or more gaming tables, such as one or more Knockout 52 tables 106, as described herein, and one or more security cameras, such as cameras 114 and cameras 116. In one or more cases, the security cameras may be positioned to capture images of a designated area of the casino floor 118. For example, one or more cameras 114, 116 may be positioned to capture images of the one or more Knockout 52 tables 106. The security room 122 may comprise one or more computing electronic devices, such as, e.g., security devices 124, to view the captured images of the security cameras 114, 116.

The network 102 may be, for example, a local area network (LAN), a telecommunications network, a wide area network (WAN), such as the Internet, a virtual local area network (VLAN), a Bluetooth® network, or any combination that can include wired, wireless, or fiber optic connections. The network 102 can also include wire cables, wireless communication links, fiber optic cables, routers, switches and/or firewalls. The network 102 interconnects the server 104, one or more security devices 124, the data storage repository 112, one or more cameras 114 and 116, and one or more gaming tables, such as the one or more Knockout 52 tables 106. In general, the network 102 may be any combination of connections and protocols capable of supporting communications between the server 104, the security devices 124, the cameras 114 and 116, the tables 106, and the program 110.

The server 104 may be a web-based server hosting the program 110. In one or more cases, the server 104 may be a web server, a blade server, a computer including one or more processors and at least one non-transitory computer readable memory, a mobile computing device, a laptop computer, a tablet computer, a netbook computer, a personal computer (PC), a desktop computer, or any programmable electronic device or computing system capable of receiving and sending data, via the network 102, and performing computer-readable program instructions. In one or more cases, the server 104 may be a data center, consisting of a collection of networks and servers providing an IT service, such as virtual servers and applications deployed on virtual servers, to an external party. In one or more cases, the server 104 may represent a computing system utilizing clustered computers and components (e.g., database server computer, application server computers, etc.) that act as a single pool of seamless resources, such as in a cloud computing environment, when accessed by one or more components within the casino 100. In one or more cases, the server 104 may be physically located in the security room 122, within another secure room of the casino 100, or offsite from the casino 100.

In one or more cases, the server 104 may comprise a data storage repository 112 for storing data including, but not limited to, one or more phases of a Knockout 52 game, a wagering game as described herein. The data storage repository 112 may be one of, a web server, a mobile computing device, a laptop computer, a tablet computer, a netbook computer, a personal computer (PC), a desktop computer, or any programmable electronic device or computing system capable of receiving, storing, and sending data, such as data and performing computer readable program instructions capable of communicating with the server 104, the one or more security devices 124, the data storage repository 112, the cameras 114 and 116, and the one or more gaming tables, such as the one or more Knockout 52 tables 106, via the network 102. In one or more cases, the data storage repository 112 may represent one or more virtual instances operating on a computing system utilizing clustered computers and components (e.g., database server computer, application server computers, etc.) that act as a single pool of seamless resources when accessed by one or more components within the casino environment 100. In one or more cases, the data storage repository 112 may be physically located in the security room 122, within another secure room of the casino 100, and/or offsite from the casino 100.

In one or more cases, the program 110 may be configured to operate on a central server, such as, e.g., the server 104, and may be utilized by the one or more security devices 124, via an application downloaded from the central server or a third-party application store and executed on the one or more security devices 124. In one or more cases, the program 110 may be a software-based program, downloaded from a central server, such as the server 104, and installed on the one or more security devices 124. In one or more cases, the program 110 may be utilized as a software service provided by a third-party cloud service provider (not shown). In one or more cases, the program 110 may be preinstalled, as software and/or firmware, on the one or more security devices 124. In one or more cases, the program 110 may be installed onto the one or more security devices 124 via an external storage device, such as a universal serial bus (USB) flash drive.

The security room 122 may comprise one or more security devices 124. In one or more cases, the one or more security devices 124 may comprise one or more electronic computing devices, such as, e.g., desktop computers, laptop computers, tablet computers, personal digital assistants (PDAs), smart phones, thin clients, and/or any other electronic device(s) or computing system(s) configured to communicate with the server 104 through the network 102. The security device 124 may be a client to the server 104. The security device 124 may be configured with a display suitable for displaying image data from the one or more cameras, such as cameras 114 and cameras 116, on the casino floor 118. The security device 124 may be configured to receive and display a cheating notification from the program 110, for the cases in which the program 110 determines that a player cheated as discussed herein. In one or more other cases, the security device 124 may be any suitable type of mobile device capable of running mobile applications, including, e.g., smart phones, tablets, slate, or any type of device that runs a mobile operating system. For example, the security device 124 may be a mobile device operated by a user, such as casino security officer. The security device 124 may be capable of connecting to a network, such as the network 102, to view, on the display of the mobile device, image data from the one or more cameras, such as cameras 114 and cameras 116, on the casino floor 118 and/or to receive and display a cheating notification from the program 110, for the cases in which the program 110 determines that a player cheated as discussed herein. For example, the casino security officer may view the image data of cameras 114 and/or cameras 116 on the display of the security device 124 while on the casino floor 118.

In one or more cases, the security device 124 may comprise a user interface for providing an end user with the capability to interact with the program 110. A user interface refers to the information (such as graphics, text, sound, and/or image data) the program 110 presents to a user and the control sequences that the user employs to control the program 110. A user interface may comprise, for example, a keyboard that allows a user to input text, a mouse or touch screen that allows a user to select an icon, or the like. A user may access the program 110 through the user interface to enable the program 110 to operate on the user's device.

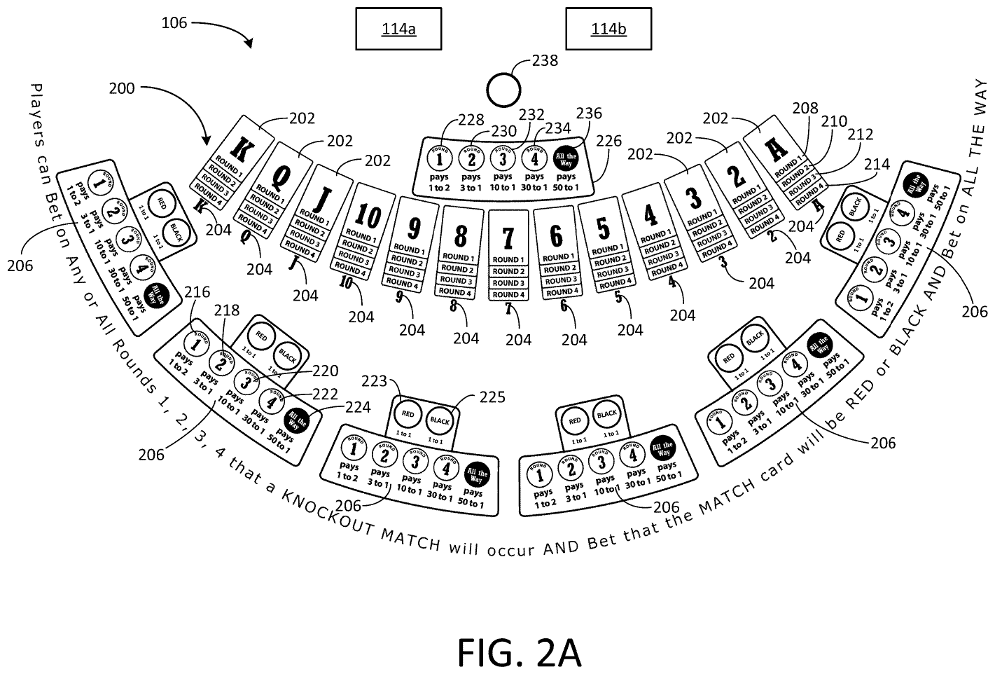

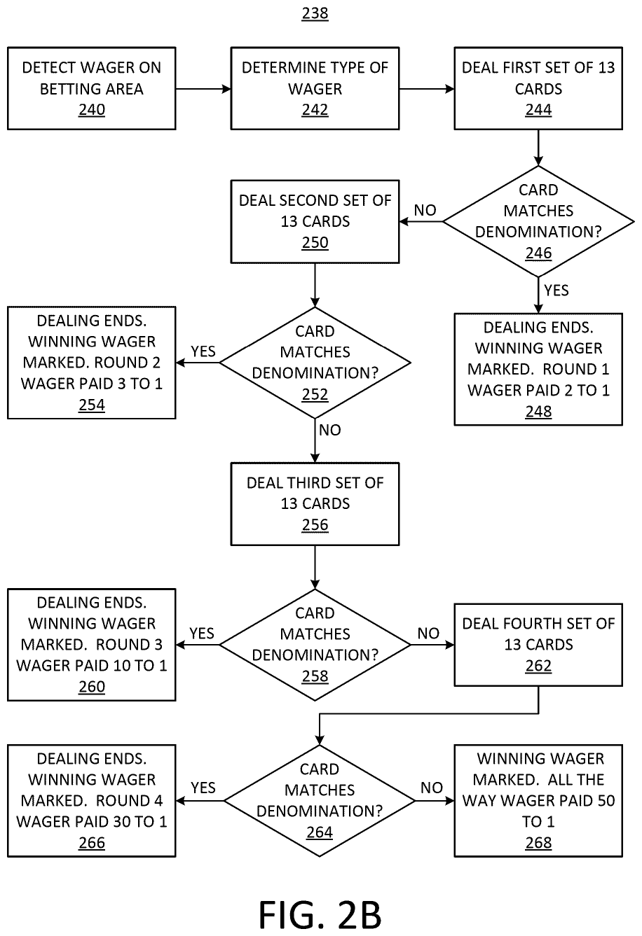

FIG. 2A is an example gaming table, such as a Knockout 52 table 106, within the casino 100. FIG. 2B is a flowchart that illustrates a method, generally designated 238, of operating the Knockout 52 table 106 of FIG. 2A.

The Knockout 52 table 106 may be an elongated game table having a horizontal surface surrounded by a sidewall to form a game play area 200 for playing Knockout 52, and more particularly, for playing a game of Knockout 52 that involves wagering. The game play area 200 may comprise marked areas that correspond to various types of wagers. One or more players may place one or more chips, markers, and/or cash (hereinafter chips, markers, and/or cash are referred to as “chips”) on the marked areas to indicate the player's wager on an outcome of a round of card dealing. The marked areas may be formed in a variety of shapes, for example, a square or rectangular shape, and may include text within the perimeter of the marked area to indicate the type of wager. The marked areas may be printed on the horizontal surface of the Knockout 52 table 106.

Knockout 52 is a casino table game, in which a shuffled standard 52-card deck or multi-deck shoe of playing cards is dealt, one by one, onto the Knockout 52 table 106. The Knockout 52 table 106 may have a layout with spaces 202 for 52 cards, each showing a denomination but not a suit, until the card matches the denomination 204 of its space, or 52 cards are dealt, whichever occurs first. Once a card matches the denomination 204 of its space, the dealing ends. Players wager on when a match will occur, or that no match occurs.

The Knockout 52 table 106 layout may have betting areas 206 on which a player or players may make a wager. During a game of Knockout 52, before any cards are dealt, players may make one or more of several types of wagers.

According to various embodiments, a player may make a wager on the betting areas 206 labeled on the layout of the Knockout 52 table 102 as a “Round 1” wager. According to various embodiments, if a player makes a “Round 1” wager, the player wins when a match occurs in the first 13 cards dealt, which are laid out left to right on the top row 208 of the spaces 202 marked with denominations A, 2, 3, 4, 5, 6, 7, 8, 9, 10, J, Q, K, in that order. According to an exemplary embodiment, this bet may pay 1 to 2. It is noted, however, that other payment odds may be incorporated, while maintaining the spirit and functionality of the present disclosure.

According to various embodiments, a player may make a wager on the betting areas 206 labeled on the Knockout 52 table 106 as a “Round 2” wager. According to various embodiments, if a player makes a “Round 2” wager, the player wins when a match occurs in the second 13 cards dealt, which are laid out left to right on the second to top row 210 of spaces 202 marked with denominations A, 2, 3, 4, 5, 6, 7, 8, 9, 10, J, Q, K, in that order. According to an exemplary embodiment, this bet may pay 3 to 1. It is noted, however, that other payment odds may be incorporated, while maintaining the spirit and functionality of the present disclosure.

According to various embodiments, a player may make a wager on the betting areas 206 labeled on the Knockout 52 table 106 as a “Round 3” wager. According to various embodiments, if a player makes a “Round 3” wager, the player wins if a match occurs in the third 13 cards dealt, which are laid out left to right on the third to top row 212 of spaces 202 marked with denominations A, 2, 3, 4, 5, 6, 7, 8, 9, 10, J, Q, K, in that order. According to an exemplary embodiment, this bet may pay 10 to 1. It is noted, however, that other payment odds may be incorporated, while maintaining the spirit and functionality of the present disclosure.

According to various embodiments, a player may make a wager on the betting areas 206 labeled on the Knockout 52 table 106 as a “Round 4” wager. According to various embodiments, if a player makes a “Round 4” wager, the player wins if a match occurs in the fourth, or last, 13 cards dealt, which are laid out left to right on the fourth to top row 214 (i.e., the bottom row) of spaces 202 marked with denominations A, 2, 3, 4, 5, 6, 7, 8, 9, 10, J, Q, K, in that order. According to an exemplary embodiment, this bet may pay 30 to 1. It is noted, however, that other payment odds may be incorporated, while maintaining the spirit and functionality of the present disclosure.

According to various embodiments, a player may make a wager on the betting areas 206 labeled on the Knockout 52 table 106 as an “All the Way” wager. According to various embodiments, if a player makes an “All the Way” wager, the player wins if 52 cards are dealt without a match occurring. According to an exemplary embodiment, this bet may pay 50 to 1, or, alternatively, may be offered at 55 to 1 odds. It is noted, however, that other payment odds may be incorporated, while maintaining the spirit and functionality of the present disclosure.

According to various embodiments, a player may make a wager on the betting areas 206 labeled on the Knockout 52 table 106 as a color wager (e.g., a “Red” wager, a “Black” wager, etc.), wagering on the color of the matching card. According to various embodiments, if a player makes a color wager, the player wins when a match occurs and the color of the matching card matches the color on which the wager was made. For example, if the player makes a “Red” wager, the player wins when the matching card is a red card, and, if the player makes a “Black” wager, the player wins when the matching card is a black card. According to an exemplary embodiment, this bet may pay 1 to 1. It is noted, however, that other payment odds may be incorporated, while maintaining the spirit and functionality of the present disclosure.

According to various embodiments, the betting areas 206 on the Knockout 52 table 106 may comprise a space 216 on which the player make a “Round 1” wager, a space 218 on which the player make a “Round 2” wager, a space 220 on which the player make a “Round 3” wager, a space 222 on which the player make a “Round 4” wager, a space 224 on which the player make an “All the Way” wager, a space 223 on which to make a “Red” wager, and a space 225 on which to make a “Black” wager.

According to various embodiments, betting during a Knockout 52 game ceases prior to the dealing of the first card in the first round.

According to various embodiments, the game play area 200 may comprise a winning wager indication area 226. The winning wager indication area 226 may comprise an area 228 for indicating that a Round 1 wager is a winning wager. The winning wager indication area 226 may comprise an area 230 for indicating that a Round 2 wager is a winning wager. The winning wager indication area 226 may comprise an area 232 for indicating that a Round 3 wager is a winning wager. The winning wager indication area 226 may comprise an area 234 for indicating that a Round 4 wager is a winning wager. The winning wager indication area 226 may comprise an area 236 for indicating that an All the Way wager is a winning wager. According to various embodiments, the game play area 200 may comprise a marker 238 configured to be placed on the winning wager indication area 226 to indicate the winning wager.

It is understood that the wagers and game play described above is illustrative to encompass a traditional game of Knockout 52, and other wagers and game play from other versions of Knockout 52 may be incorporated the Knockout 52 game. Moreover, it will be understood that the embodiments of the disclosure detailed herein are contemplated as being incorporated into any and all versions of Knockout 52 played and any current and future methods of playing Knockout 52.

Referring now to FIG. 2B, a flowchart that illustrates a method, generally designated 238, of operating the Knockout 52 table 106 of FIG. 2A is illustratively depicted, in accordance with various embodiments of the present disclosure.

At 240, a wager may be detected on the betting areas 206. For example, a dealer at the Knockout 52 table 106 may detect that a player has placed a wager on the betting areas 206, such as the space 216 on which the player may make a “Round 1” wager, the space 218 on which the player may make a “Round 2” wager, a space 220 on which the player may make a “Round 3” wager, the space 222 on which the player may make a “Round 4” wager, the space 224 on which the player may make an “All the Way” wager, a space 223 on which the player may make a “Red” wager, and a space 225 on which the player may make a “Black” wager.

By placing the wager on a betting area 206, the player initiates a wager. At 242, the dealer may determine a type of wager that has been made by the player (e.g., a Round 1 wager, a Round 2 wager, a Round 3 wager, a Round 4 wager, or an All the Way wager).

At 244, the dealer deals one or more of a first set of 13 cards, which are laid out left to right on the top row 208 of the spaces 202 marked with denominations A, 2, 3, 4, 5, 6, 7, 8, 9, 10, J, Q, K, in that order. At 246, the dealer determines whether a card, of the first 13 cards, matches the denomination of the space 202 in which it was placed.

According to various embodiments, when a card, of the first set of 13 cards, matches the denomination of the space 202 in which it was placed, then, at 248, dealing ends, the Round 1 wager is identified as a winning wager, and the dealer pays the player 1 to 2 on the Round 1 wager if the player made a Round 1 wager, and 1 to 1 on a color wager (e.g., a “Red” wager, a “Black” wager, etc.) when the color of the matching card matches the color of the color wager. It is noted, however, that other payment odds may be incorporated, while maintaining the spirit and functionality of the present disclosure. According to various embodiments, when dealing ends, the winning wager (the Round 1 wager) is marked on the winning wager indication area. This may be an indicator to one or more sensing devices (e.g., cameras or other suitable devices) that the Round 1 wager is the winning wager.

According to various embodiments, when no card, of the first set of 13 cards, matches the denomination of the space 202 in which it was placed, the first round ends and, at 250, the dealer deals one or more of a second set of 13 cards, which are laid out left to right on the second to top row 210 of spaces 202 marked with denominations A, 2, 3, 4, 5, 6, 7, 8, 9, 10, J, Q, K, in that order. At 252, the dealer determines whether a card, of the second set of 13 cards, matches the denomination of the space 202 in which it is placed.

According to various embodiments, when a card, of the second set of 13 cards, matches the denomination of the space 202 in which it is placed, then, at 254, the Round 2 wager is identified as a winning wager, dealing ends and the dealer pays the player 3 to 1 on the Round 2 wager if the player made a Round 2 wager, and 1 to 1 on a color wager (e.g., a “Red” wager, a “Black” wager, etc.) when the color of the matching card matches the color of the color wager. It is noted, however, that other payment odds may be incorporated, while maintaining the spirit and functionality of the present disclosure. According to various embodiments, when dealing ends, the winning wager (the Round 2 wager) is marked on the winning wager indication area. This may be an indicator to one or more sensing devices (e.g., cameras or other suitable devices) that the Round 2 wager is the winning wager.

According to various embodiments, when no card, of the second set of 13 cards, matches the denomination of the space 202 in which it was placed, the second round ends and, at 256, the dealer deals one or more of a third set of 13 cards, which are laid out left to right on the third to top row 212 of spaces 202 marked with denominations A, 2, 3, 4, 5, 6, 7, 8, 9, 10, J, Q, K, in that order. At 258, the dealer determines whether a card, of the third set of 13 cards, matches the denomination of the space 202 in which it is placed.

According to various embodiments, when a card, of the third set of 13 cards, matches the denomination of the space 202 in which it is placed, then, at 260, dealing ends, the Round 3 wager is identified as a winning wager, and the dealer pays the player 10 to 1 on the Round 3 wager if the player made a Round 3 wager, and 1 to 1 on a color wager (e.g., a “Red” wager, a “Black” wager, etc.) when the color of the matching card matches the color of the color wager. It is noted, however, that other payment odds may be incorporated, while maintaining the spirit and functionality of the present disclosure. According to various embodiments, when dealing ends, the winning wager (the Round 3 wager) is marked on the winning wager indication area. This may be an indicator to one or more sensing devices (e.g., cameras or other suitable devices) that the Round 3 wager is the winning wager.

According to various embodiments, when no card, of the third set of 13 cards, matches the denomination of the space 202 in which it was placed, the third round ends and, at 262, the dealer deals one or more of a fourth set of 13 cards, which are laid out left to right on the fourth to top row 214 (i.e., the bottom row) of spaces 202 marked with denominations A, 2, 3, 4, 5, 6, 7, 8, 9, 10, J, Q, K, in that order. At 264, the dealer determines whether a card, of the fourth set of 13 cards, matches the denomination of the space 202 in which it is placed.

According to various embodiments, when a card, of the fourth set of 13 cards, matches the denomination of the space 202 in which it is placed, then, at 266, dealing ends, the Round 4 wager is identified as a winning wager, and the dealer pays the player 30 to 1 on the Round 4 wager if the player made a Round 4 wager, and 1 to 1 on a color wager (e.g., a “Red” wager, a “Black” wager, etc.) when the color of the matching card matches the color of the color wager. It is noted, however, that other payment odds may be incorporated, while maintaining the spirit and functionality of the present disclosure. According to various embodiments, when dealing ends, the winning wager (the Round 4 wager) is marked on the winning wager indication area. This may be an indicator to one or more sensing devices (e.g., cameras or other suitable devices) that the Round 4 wager is the winning wager.

According to various embodiments, when no card, of the fourth set of 13 cards, matches the denomination of the space 202 in which it was placed, the fourth round ends and, at 268, the All the Way wager is identified as a winning wager and the dealer pays the player 50 to 1 on the All the Way wager if the player made an All the Way wager. It is noted, however, that other payment odds may be incorporated, while maintaining the spirit and functionality of the present disclosure. According to various embodiments, when dealing ends, the winning wager (the All the Way wager) is marked on the winning wager indication area. This may be an indicator to one or more sensing devices (e.g., cameras or other suitable devices) that the All the Way wager is the winning wager.

Although the embodiments discussed and illustrated with respect to FIGS. 2A-2B focus on physical gaming tables, such as a Knockout 52 table 106, the embodiments are not so limited. For example, the embodiments, in particular with respect to method 230, may be implemented “virtually” as a game on an electronic computing device, such as, e.g., a video gaming terminal, a mobile application on a smart phone, or on a personal computer, in which a user may interact virtually with the wagering game, via, e.g., method 230. For example, with respect to a virtual Knockout 52 table 106, displayed by images on a user's electronic computing device, the user may place a wager on the betting area 206, and the computer may virtual deal the first set of 13 cards, the second set of 13 cards, the third set of 13 cards, and/or the fourth set of 13 cards, which may be represented by images displayed on the electronic computing device. The game may operate on a dedicated electronic computing device located, for example, on the floor of a casino. In one or more other cases, the game may be stored on the server 104 and/or may be accessed remotely by the electronic computing device, via an Internet-based casino.

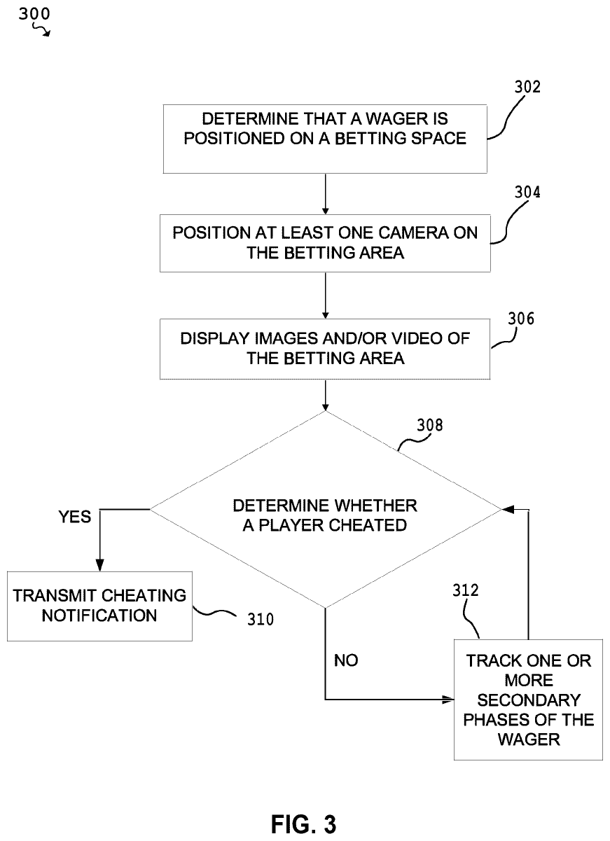

Referring now to FIG. 3, a flowchart that illustrates a method, generally designated 300, of monitoring the Knockout 52 table 106 of FIG. 2A, in accordance with various embodiments of the present disclosure.

In one or more cases, the program 110 may be configured to monitor the gaming table (e.g., the Knockout 52 table 106) and one or more wagers to detect a player cheating at the gaming table. At an initial phase of playing a round at the Knockout 52 table 106, the one or more cameras focused on the gaming table may be configured to capture images and/or video of the entire gaming table. Alternatively, one or more cameras may be positioned on a particular area of the gaming table, and one or more other cameras may be positioned on either another area of the gaming table or the entire gaming table.

In one or more cases, at 302, the program 110 may be configured to determine that a wager has been placed on the betting area 206.

In one or more cases, the program 110 may be configured to determine that the wager has been positioned on the betting area 206 by analyzing image data captured from the one or more cameras 114, 116. The one or more cameras 114, 116 may be positioned to capture one or more images and/or video of the Knockout 52 table 106. The one or more cameras 114, 116 may be positioned on the ceiling above the respective tables. For example, camera 114a and camera 114b may be positioned on the ceiling above the Knockout 52 table 106. It should be understood that, in one or more cases, the Knockout 52 table 106 may comprise less than two cameras, and that in one or more other cases, the Knockout 52 table 106 may comprise more than two cameras. In one or more cases, the cameras 114a and 114b may be positioned such that each camera is configured to capture images and/or video of the entire Knockout 52 table 106. The cameras 114a and 114b may each be configured to capture images and/or video of a portion of the Knockout 52 table 106. For example, camera 114a may be positioned and configured to capture a video of betting area 206a, and camera 114b may be positioned and configured to capture a video of the game play area 200. The cameras may be configured to transmit, via the network 102, the data related to the captured images and/or video to the one or more security devices 124. The one or more security devices 124 may be configured to receive the data and display the images and/or video on the display of the one or more security devices 124. The cameras may be configured to capture and transmit the data and the security devices 124 may display the related images and/or video in real-time.

In one or more cases, the cameras 114, 116 may be configured to transmit, via the network 102, the data related to the captured images and/or video to the program 110. The program 110, using one or more image processing methods, may be configured to analyze the data to determine when a wager is positioned on a betting area of a respective gaming table. For example, for the cases in which a wager is positioned on a betting area, such as betting area 206, the program 110 may be configured to determine that the received data includes one or more features of the wager. The one or more features of the wager may comprise a shape of the chip or marker, a color of the chip or marker, a number of chips or markers positioned on the play area, or the like.

In one or more cases, the program 110 may be configured to determine that the wager is positioned on the betting area by analyzing the weight of objects, such as the chips, positioned on the surface of the betting area. For example, the Knockout 52 table 106 may comprise one or more weight sensors positioned beneath the surface of each of the betting areas 206 on the Knockout table 106. In one or more cases, the weight sensors may be configured to activate and collect weight measurements according to the active betting area 206. For example, the weight sensor beneath the betting area 206 may be configured to collect weight measurements. The weight sensor may be configured to monitor the weight of one or more objects that are positioned on the surface of the respective betting area 206. The weight sensor may be connected to the server 104 and program 110 via the network 102. The weight sensor may be configured to collect the weights of the objects placed on the betting area 206 and transmit the weights to the program 110. For the cases in which the program 110 determines that the weight increases from 0 to another weight, the program 110 may be configured to determine that a wager is positioned on the betting area 206.

In one or more cases, the program 110 may be configured to determine that a wager is positioned on the betting area 206 based on a signal transmitted by the dealer at the gaming table 106 or a casino security officer monitoring video, displayed on the security device 124 of the gaming table 106. For example, after a player and/or dealer places the player's wager on the betting area 206, the dealer may press a button that sends a signal to the program 110 to indicate that the wager is positioned on the betting area 206.

According to various embodiments, at 304, having determined that a wager is positioned on a betting area 206 of the gaming table 106, at least one camera may be positioned on the betting area 206. In one or more cases, the program 110 may be configured to send a control signal to at least one camera to position the camera on the betting area 206. The control signal may be a signal to rotate a camera such that the camera is positioned to capture images and/or video of only the betting area 206.

With respect to the Knockout 52 game, the control signal may be a signal to have the camera zoom in on the betting area for the cases in which the camera is positioned to capture images and/or video of the entire Knockout 52 table 106. In one or more cases, the program 110 may be configured to send a control signal to one camera, such as camera 114a, to capture images and/or video of the entire Knockout 52 table 106, and send another control signal to another camera, such as camera 114b, to capture images and/or video of the betting area 206. In one or more cases, the casino 100 may include one camera per betting area 206. In one or more other cases in which the Knockout 52 table 106 utilizes only one camera, the program 110 may be configured to send a control signal to a camera to capture the entire Knockout 52 table 106. The program 110 may be configured to receive the data related to the captured images and/or video, and, using one or more image processing methods, may be configured to analyze the data of the one or more betting areas 206 to determine when a wager is positioned on one or more of the betting areas 206.

Having determined that one or more wagers are positioned on a betting area 206 of a respective gaming table 106, the program 110 may be configured to analyze information of the one or more wagers. For instance, the program 110 may be configured to analyze a wager, using an image processing technique, to determine the position of the wager on the betting area 206, the amount of the wager that was placed, or the like. The program 110 may be configured to determine the position of the wager on the betting area to distinguish the wagers placed on the betting area 206 by other players. To determine the amount of the wager, the program 110 may be configured to determine a number of chips and the value of each chip based on their respective colors. The program 110 may be configured to store the number of chips and the value of each chip in the data storage repository 112 and may be configured to retrieve this information to compare the amount of the wager during one or more phases of the Knockout 52 game. The dealer may gesture that no more bets may be placed on the gaming table, i.e., an initial phase of the Knockout 52 game, in which the program 110 may be configured to determine that the amount of the wager on the betting area is the total amount of the wager that Knockout 52 game. According to various embodiments, the initial phase may occur when it is detected that the dealer has begun dealing the first set of 13 cards. The program 110 may be configured to compare the total amount of the wager at the initial phase to one or more secondary phases of the Knockout 52 game as discussed herein.

According to various embodiments, at 306, the program 110 may be configured to display the images and/or video of the betting area 206. The program 110 may be configured to display the images and/or video of the betting area 206 on one or more security devices 124. In some cases, the program 110 may be configured to send a signal to automatically display the betting area 206 on the one or more security devices 124. In some other cases, the program 110 may be configured to send a signal that displays a query on the display of the one or more security devices 124. The query may present the user with an option of viewing the betting area 206 on the display of the security device 124. For the cases in which the user selects the option of viewing the betting area 206, for example, by selecting an affirmative icon on the display, the program 110 may be configured to send a signal to the security device to display the betting area 206.

In one or more cases, at 308, the program 110 may be configured to determine whether a player cheated. To determine whether a player cheated, the program 110 may be configured to analyze the wager positioned on a betting area 206 during and/or after a secondary phase of the Knockout 52 game. The program 110 may be configured to analyze the wager to determine the amount of the wager during and/or after the secondary phase. To determine the amount of a wager, the program 110 may be configured to use an image processing technique on the wager to determine the number of chips and the value of each chip based on their respective colors. The program 110 may be configured to compute the amount of the wager based on the determined number of chips and the value of each chip. To determine whether a player cheated, the program 110 may be configured to compare the amount of the wager determined during and/or after the secondary phase to the amount of the wager determined at the initial phase of the Knockout 52 game.

The program 110 may be configured to detect when the secondary phase occurs during the Knockout 52 game by determining when one or more events that correspond to the secondary phase occur. For example, the program 110 may detect a secondary phase being the dealing, by the dealer, of the first set of 13 cards. In one or more cases, the program 110 may be configured to determine when one or more events that correspond to the secondary phase occur by analyzing image data captured from the one or more cameras as discussed herein. In one or more other cases, the program 110 may be configured to determine when one or more events that correspond to the secondary phase occur by receiving a signal transmitted by the dealer at the Knockout 52 table 106 or a casino security officer monitoring video, displayed on the security device 124 of the Knockout 52 table 106. For example, after the dealer begins dealing the first set of 13 cards, the dealer may press a button that sends a signal to the program 110 to indicate that the secondary phase that relates to the dealing of the first set of 13 cards occurred. Having detected a secondary phase of the Knockout 52 game, the program 110 may be configured to compare the amount of the wager determined during and/or after the secondary phase to the amount of the wager determined at the initial phase of the Knockout 52 game. According to various embodiments, when a marker 238 is placed on the winning wager indication area 226, the program 110 may be able to identify the position of the marker 238 to identify the winning wager.

According to various embodiments, a secondary phase of the Knockout 52 game may comprise (i) detecting that the dealer has begun dealing the second set of 13 cards, (ii) detecting that the dealer has begun dealing the third set of 13 cards, (iii) detecting that the dealer has begun dealing the fourth set of 13 cards, and (iv) detecting that the fourth set of cards has been completely dealt. According to various embodiments, the program 110 may be configured to detect that the cards are removed from the card space 202, which indicates to the program 110 that the wager for the instant Knockout 52 game is complete and the next secondary phase to detect is the dealer beginning dealing the first set of 13 cards during a subsequent Knockout 52 game. According to various embodiments, at one or more of the secondary phases that occur at the Knockout 52 table 106, the program 110 may be configured to analyze one or more wagers placed on the betting area 206 to determine whether a player cheated as described herein.

According to various embodiments, for the cases in which the program 110 has determined that the player cheated, the program 110, at 310, may be configured to transmit a cheating notification. For example, the program 110 may be configured to determine that the player cheated when the program 110 determines that the amount of the wager detected at a secondary phase of the Knockout 52 game is greater than or less than the amount of the wager detected at the initial phase of the Knockout 52 game. In one or more cases, the program 110 may be configured to transmit the cheating notification to a display device at the Knockout 52 table 106, such that the dealer may see the notification on the display device, and/or to the security devices 124, such that security officers may respond to the cheating notification appropriately.

According to various embodiments, for the cases in which the program 110 does not determine that the player cheated, the program 110, at 312, may be configured to track one or more secondary phases of the wager. For instance, with respect to a wager placed on the Knockout 52 table 106, if the program 110 does not detect cheating during the secondary phase of (i) detecting that the dealer has begun dealing the first set of 13 cards, the program 110 may be configured to determine that the next secondary phase to determine cheating is (ii) detecting that the dealer has begun dealing the second set of 13 cards. Having detected a next phase of the wager, the program 110 may be configured to determine whether a player cheated. This process may repeat until the player wins or loses the wager.

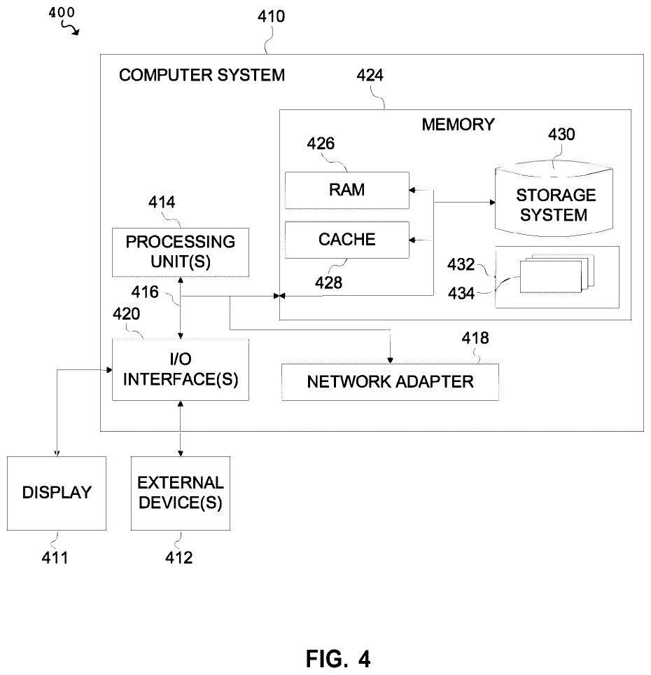

Referring now to FIG. 4, a block diagram depicting components (such as the server 104 of FIG. 1) of a data processing system is illustratively depicted, in accordance with various embodiments of the present disclosure. FIG. 4 is a block diagram, generally designated 400, depicting components of computing device capable of operating the authentication program 110 in accordance with embodiments of the present disclosure. FIG. 4 provides only an illustration of one implementation and does not imply any limitations with regard to the environments in that different embodiments may be implemented. Many modifications to the depicted environment may be made.

In one or more cases, the server 104 in the data processing environment 100 is shown in the form of a general-purpose computing device, such as computer system 410. The components of the computer system 410 may comprise, but are not limited to, one or more processors or processing units 414, a memory 424, and a bus 416 that couples various system components, including the memory 424, to the processing unit 414.

The bus 416 represents one or more of any of several types of bus structures, including a memory bus or memory controller, a peripheral bus, an accelerated graphics port, and a processor or local bus using any of a variety of bus architectures. By way of example, and not limitation, such architectures may comprise an Industry Standard Architecture (ISA) bus, a Micro Channel Architecture (MCA) bus, an Enhanced ISA (EISA) bus, a Video Electronics Standards Association (VESA) local bus, and a Peripheral Component Interconnect (PCI) bus, among other suitable buses.

The computer system 410 typically includes a variety of computer system readable media. Such media may be any available media that is accessible by the computer system 410, and it may comprise both volatile and non-volatile media, removable and non-removable media.

The memory 424 may comprise computer system readable media in the form of volatile memory, such as random access memory (RAM) 426 and/or cache memory 428. The computer system 410 may further comprise other removable/non-removable, volatile/non-volatile computer system storage media. By way of example only, the storage system 430 may be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media may be provided. In such instances, each may be connected to the bus 416 by one or more data media interfaces. As will be further depicted and described below, the memory 424 may comprise at least one computer program product having a set (e.g., at least one) of program modules that are configured to carry out the functions of embodiments.

A program/utility 432, having one or more sets of program modules 434, may be stored in the memory 424 by way of example, and not limitation, as well as an operating system, one or more application programs, other program modules, and program data. Each of the operating systems, one or more application programs, other program modules, and program data, or some combination thereof, may comprise an implementation of a networking environment. The program modules 434 may be configured to generally carry out the functions and/or methodologies of embodiments as described herein. The computer system 410 may also be configured to communicate with one or more external device(s) 412 such as, e.g., a keyboard, a pointing device, a display 411, etc., and/or one or more devices that are configured to enable a user to interact with the computer system 410 and any devices (e.g., network card, modem, etc.) that are configured to enable the computer system 410 to communicate with one or more other computing devices. Such communication may occur via Input/Output (I/O) interface(s) 420. Still yet, the computer system 410 may be configured to communicate with one or more networks such as a local area network (LAN), a general wide area network (WAN), and/or a public network (e.g., the Internet) via a network adapter 418. As depicted, the network adapter 418 may be configured to communicate with the other components of the computer system 410 via the bus 416. It should be understood that, although not shown, other hardware and/or software components, such as, e.g., microcode, device drivers, redundant processing units, external disk drive arrays, RAID systems, tape drives, and data archival storage systems may be used in conjunction with the computer system 410.

The embodiments described in the present disclosure may relate to a system, a method, and/or a computer program product. The computer program product may include a computer readable storage medium (or media) having computer readable program instructions for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions, cloud storage, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a non-transitory computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the embodiments may be instruction-set-architecture (ISA) instructions, machine instructions, machine dependent instructions, microcode, firmware instructions, state-setting data, or either source code or object code written in any combination of one or more programming languages, including an object oriented programming language such as C++ and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In one or more cases, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments described in the present disclosure.

Aspects of the embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by non-transitory computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may be executed substantially concurrently, the blocks may sometimes be executed in the reverse order, depending upon the functionality involved, or the blocks may sometimes be executed out of order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts or carry out combinations of special purpose hardware and computer instructions.

The various embodiments described above are provided by way of illustration only and should not be construed to limit the claims attached hereto. It will be appreciated that one or more embodiments of the above-disclosed and other features and functions, or alternatives thereof, may be desirably combined into many other different systems or applications.

What is claimed is:

1. A method for monitoring a wagering game, the method comprising:
determining an initial phase of a wagering game;
determining that a wager is positioned on a betting area of the wagering game;
determining an initial value of the wager at the initial phase, the determining the initial value of the wager comprising:
capturing, via a camera positioned on the wagering game, one or more images of the wager on the play area; and
analyzing image data of the one or more images of the wager to determine an initial value of the wager;
determining at least one secondary phase of the wagering game;
determining a value of the wager at one or more of the at least one secondary phases of the wagering game; and
comparing the value of the wager at the initial phase to the value of the wager at the one or more of the at least one secondary phases.

2. The method of claim 1, further comprising, when the value of the wager at the initial phase is different from the value of the wager at the one or more of the at least one secondary phases, determining that a player has cheated.

3. The method of claim 1, wherein, during the wagering game:
a dealer deals one or more of a first set of 13 cards, which are laid out left to right on a row of spaces marked with denominations A, 2, 3, 4, 5, 6, 7, 8, 9, 10, J, Q, K, in that order; and
when a card, of the first set of 13 cards, matches the denomination of a space on which it was placed, dealing ends.

4. The method of claim 3, wherein the determining the initial phase of the wagering game comprises detecting that the dealer has begun dealing the first set of 13 cards.

5. The method of claim 3, wherein, during the wagering game:
when no card, of the first set of 13 cards, matches the denomination of a space in which it was placed, the dealer deals one or more of a second set of 13 cards, which are laid out left to right on a second row of spaces marked with denominations A, 2, 3, 4, 5, 6, 7, 8, 9, 10, J, Q, K, in that order; and
when a card, of the second set of 13 cards, matches the denomination of a space in which it is placed, dealing ends.

6. The method of claim 5, wherein the determining the at least one secondary phase of the wagering game comprises detecting that the dealer has begun dealing the second set of 13 cards.

7. The method of claim 5, wherein, during the wagering game:
when no card, of the second set of 13 cards, matches the denomination of the space in which it was placed, the dealer deals one or more of a third set of 13 cards, which are laid out left to right on a third row of spaces marked with denominations A, 2, 3, 4, 5, 6, 7, 8, 9, 10, J, Q, K, in that order; and
when a card, of the third set of 13 cards, matches the denomination of a space in which it is placed, dealing ends.

8. The method of claim 7, wherein the determining the at least one secondary phase of the wagering game comprises detecting that the dealer has begun dealing the third set of 13 cards.

9. The method of claim 7, wherein, during the wagering game:
when no card, of the third set of 13 cards, matches the denomination of the space in which it was placed, the dealer deals one or more of a fourth set of 13 cards, which are laid out left to right on a third row of spaces marked with denominations A, 2, 3, 4, 5, 6, 7, 8, 9, 10, J, Q, K, in that order; and
when a card, of the fourth set of 13 cards, matches the denomination of a space in which it is placed, dealing ends.

10. The method of claim 9, wherein the determining the at least one secondary phase of the wagering game comprises detecting that the dealer has begun dealing the fourth set of 13 cards.

11. The method of claim 9, wherein the determining the at least one secondary phase of the wagering game comprises detecting that the fourth set of cards has been completely dealt.

12. The method of claim 1, wherein the determining the value of the wager at the one or more of the at least one secondary phases of the wagering game comprises:
capturing, via the camera, in response to determining a secondary phase of the wagering game, one or more images of the wager at the secondary phase of the wagering game; and
analyzing image data of the one or more images of the wager at the secondary phase of the wagering game to determine the value of the wager at the secondary phase of the wagering game.

13. The method of claim 1, wherein the determining that the wager is positioned on the betting area further comprises:
capturing, via the camera positioned on the wagering game, one or more images of the wagering game; and
analyzing image data of the one or more images to determine whether a feature of the wager is included in the image data of the play area.

14. The method of claim 1, wherein the determining that the wager is positioned on the betting area further comprises:
monitoring a weight of the betting area, wherein the betting area is positioned on a weight sensor; and
determining that the wager is positioned on the betting area when the weight of the betting area increases.

15. The method of claim 1, wherein:
the determining that the wager is positioned on the betting area further comprises receiving a signal transmitted by a press of a button located on at least one of an area of the wagering game and a display screen of a security device, and
the press of the button indicates that the wager is positioned on the play area.

16. The method of claim 1, wherein the determining that the wager is positioned on the betting area indicates that the player initiated the wager.

17. The method of claim 1, further comprising, during the wagering game:
identifying a winning wager, and
when the winning wager is identified, placing a marker on a winning wager indication area indicating which wager is the winning wager.

18. The method of claim 17, wherein, when a player makes a color wager and a dealt card matches a denomination of a space on which it was placed, the color wager is the winning wager when a color of the dealt card matches a color of the color wager.

19. The method of claim 18, wherein the color wager comprises a red color wager.

20. The method of claim 18, wherein the color wager comprises a black color wager.
